(19) United States
(12) Patent Application Publication
(10) Pub. No.: US 2026/0109799 A1
(43) Pub. Date: Apr. 23, 2026

(54) ORGANIC REINFORCEMENT OF AN ELASTOMER WITH THE IN SITU SYNTHESIS OF A POLYIMIDE PHASE BY REACTIVE EXTRUSION

(71) Applicants: UNIVERSITÉ CLAUDE BERNARD LYON 1 (UCBL), Villeurbanne (FR); CENTRE NATIONAL DE LA RECHERCHE SCIENTIFIQUE (CNRS), Paris (FR); UNIVERSITÉ JEAN MONNET SAINT-ETIENNE, Saint-Etienne Cedex 2 (FR); INSTITUT NATIONAL DES SCIENCES APPLIQUÉES DE LYON (INSA LYON), Villeurbanne CEDEX (FR)

(72) Inventors: Philippe CASSAGNAU, Villeurbanne (FR); Karim DELAGE, Villeurbanne (FR); Véronique BOUNOR-LEGARE, Paris (FR); Catherine MARESTIN, Paris (FR); Charlotte DUBOIS, Seneffe (BE); Nicolas GAROIS, Amilly (FR)

(21) Appl. No.: 19/155,097

(22) PCT Filed: Feb. 15, 2024
(86) PCT No.: PCT/EP2024/053812

§ 371 Date: Aug. 8, 2025

(30) Foreign Application Priority Data
Feb. 15, 2023 (EP) 23315031.7

(51) Int. Cl. C08F 255/06; C08G 73/10

(52) U.S. Cl. CPC C08F 255/06; C08G 73/1007

(57) ABSTRACT

The present disclosure relates to a process to produce a reinforced elastomeric material and to the reinforced elastomeric material. The process comprises the steps of providing components comprising a grafted elastomer, one or more dianhydrides, and one or more diamines; wherein the grafted elastomer is provided at a content of at least 60 wt. % based on the total weight of the components; performing in situ synthesis of a polyimide phase in the grafted elastomer by reactive extrusion of the components in a twin-screw extruder comprising main hopper wherein the screw profile comprises two or more reverse conveying elements forming two or more hot zones to form an elastomer-polyimide blend; and recovering said elastomer-polyimide blend being a reinforced elastomeric material.

### TECHNOLOGICAL FIELD

The present disclosure relates to a process for producing a reinforced elastomeric material comprising a continuous phase being an elastomer and another phase being a polyimide which is formed in situ. The disclosure also relates to the reinforced elastomeric material obtained by such a process.

### TECHNOLOGICAL BACKGROUND

Ethylene-propylene-diene rubber (EPDM) is one of the most widely used synthetic rubbers. The presence of diene enables for example sulfur vulcanization or peroxide crosslinking with high efficiency. This low-unsaturated, non-polar polymer has excellent resistance to heat, oxidation, irradiation, ozone, and against polar solvents. Due to those characteristics, EPDM is used in a broad range of applications in the industry, such as parts for automotive, electric insulation, wires, cables, and footwear.

To obtain the best possible properties, elastomers are most of the time reinforced with fillers. Carbon black and silica are the most common fillers in the rubber industry and have been used since the beginning of elastomers. The role of the fillers is to reinforce the elastic matrix, increasing elastic modulus, fracture, and abrasion properties. This reinforcing effect is governed by many parameters, including the nature of the filler, the shape, size, and surface area of the particles as well as the dispersion and distribution in the matrix. Silica fillers tend to form agglomerates due to the very strong hydrogen bonding of the silanol groups between the particles, resulting in poor dispersion in the matrix. The addition of such fillers leads to increased viscosity of the material and thus decreases the processing ability of the material.

Moreover, the elastomers reinforced with inorganic fillers have a striking strain dependence of the storage modulus (G′), with a high decrease of G′ from low oscillatory strain amplitudes (in the range from 0.1 to 10%). This phenomenon is called the Payne effect and has been attributed to the breakdown of the three-dimensional network constructed by the filler aggregates in the matrix.

Rubbers can also be toughened by the addition of a rigid polymer phase. Indeed, thermoplastic/rubber blends have been deeply studied since they combine the unique properties of crosslinked rubbers (high elastic recovery and strain at break) with the ease of processing and higher mechanical properties of thermoplastics (Young's modulus and mechanical strength). Most of these studies deal with the toughening of a thermoplastic thanks to the dispersion of an elastomer, or with the formation of thermoplastic elastomers (TPE). On the contrary, far less attention has been paid to rubbers reinforced by thermoplastics. Nevertheless, the following examples of the reinforcement of an EPDM matrix can be detailed:

Bouchart, V., et al. in “Study of EPDM/PP polymeric blends: mechanical behavior and effects of compatibilization” (Comptes Rendus Mecanique, 2008. 336(9): p. 714-721) incorporated polypropylene (PP) in an EPDM matrix, using maleic anhydride grafted polypropylene (PP-g-MA) as a compatibilizer. They prepared EPDM/PP 70/30 wt. % blends with either 3 or 7 wt. % of PP-g-MA in a twin screw extruder at 210° C. The addition of polypropylene to the elastomeric matrix multiplied by two the tensile strength but decreased by half the strain at break of the material.

Bragaglia, M., et al. in “Compatibilization of an immiscible blend of EPDM and POM with an Ionomer” (Journal of Applied Polymer Science, 2021, 138 (20): p. 50423) developed EPDM/polyoxymethylene (POM) blends compatibilized with an ionomer, poly(ethylene-co-methacrylic acid)-Zn²⁺ (EMAA-Zn²⁺). EPDM/POM 80/20 wt. % were blended in an internal mixer at 190° C., with compatibilizer content varying from 0 to 20 wt. % relative to the total amount of polymers. After homogenization of the blend, 4 phr (parts per hundred of rubber) of dicumyl peroxide (DCP) were added to the blend. The samples were finally cured into thin sheets at 160° C. under 200 bars. The presence of 20 wt. % of ionomer decreased the POM particles' diameter from 10.8 μm to 1.3 μm. The addition of hard POM particles increased the overall mechanical properties of EPDM. The materials with the best properties contained 20 wt. % of ionomer and resulted in a 54% increase in Young's modulus, a 140% increase in tensile strength, and a 97% increase in strain at break.

Singh, S., et al., in “Development of polyimide-nanosilica filled EPDM based light rocket motor insulator compound: Influence of polyimide-nanosilica loading on thermal, ablation, and mechanical properties” (Composites Part A: Applied Science and Manufacturing, 2013. 44: p. 8-15) developed polyimide-nanosilica filled EPDM nanocomposites. To achieve a homogeneous blend, they used maleic anhydride grafted EPDM, and a polyimide powder (Tg=315° C.). The polyimide and the nanosilica contents were varied from 0 to 10 phr. The blends were prepared in an internal mixer at 120° C. and cured under pressure at 150° C. for 30 min. The tensile strength and the hardness were increased with the incorporation of polyimide particles. Indeed, for 5 phr of polyimide and without silica, the tensile strength increased from 1.96 MPa for pure EPDM to 2.5 MPa for the nanocomposite. The addition of nanosilica further increased the strength of the material.

The studies depicted an improvement in the mechanical properties, but it was not significant. There is still a need for a solution to reinforce elastomers wherein the reinforced material shows an improvement in mechanical properties.

### SUMMARY OF THE DISCLOSURE

One or more of the above needs can be fulfilled by the formation in situ in an elastomeric matrix of a polyimide phase.

According to a first aspect, the disclosure provides a process to produce a reinforced elastomeric material remarkable in that it comprises:
a) providing components comprising a grafted elastomer, one or more dianhydrides, and one or more diamines; wherein the grafted elastomer is provided at a content of at least 60 wt. % based on the total weight of the components;
b) performing in situ synthesis of a polyimide phase in the grafted elastomer by reactive extrusion of the components in a twin-screw extruder comprising a main hopper wherein the screw profile comprises two or more reverse conveying elements forming two or more hot zones to form an elastomer-polyimide blend; and
c) recovering said elastomer-polyimide blend being a reinforced elastomeric material wherein the polyimide of the elastomer-polyimide blend is present at a content from 3 to 40 wt. % based on the total weight of the reinforced elastomeric material.

Surprisingly, the in situ synthesis of a polyimide (PI) phase dispersed in a grafted elastomeric matrix, such as a grafted ethylene-propylene-diene monomer elastomeric matrix, led to the reinforcement of the elastomer phase. A nanometric nodular dispersion of PI was obtained, with average diameters below 1000 nm and for example between 130 and 240 nm depending on the polyimide concentration. This morphology was stabilized due to copolymer formation through the reaction between the maleic anhydride groups on the elastomer and the polyimide amine end groups.

The elastomer phase was reinforced with the in situ synthesis of a polyimide phase. The mechanical properties of the material were highly improved, and the stiffening of the material further increased with the polyimide content.

As shown by the examples, ethylene-propylene-diene monomer rubber grafted with maleic anhydride functions (EPDM-g-MA) was organically reinforced by reactive extrusion from the in situ synthesis of a polyimide (PI) phase. The elastomer-polyimide blends were reactively processed in a twin-screw extruder, preferably with a temperature ranging between 150° C. and 250° C., and/or, with the PI content varying from 3 to 40 wt. % based on the total weight of the reinforced elastomeric material, or from 5 to 40 wt. %, Transmission Electron Microscopy (TEM) depicted a very fine nodular dispersion of the polyimide phase with diameters for example ranging from 130 to 240 nm depending on the PI concentration.

The reinforcement of the elastomer was evidenced by a high increase in Young's modulus and tensile strength, and the stiffness of the material was further increased with the PI content. The linear regime, measured from the variation of the storage modulus versus strain, was not impacted by this organic reinforcement. Additionally, the crosslinking of the elastomer-polyimide blend with a crosslinking agent based on the total weight of the elastomer-polyimide blend showed that the polyimide phase did not impact the creation of the crosslinked network. The decrease in the swelling ratio and the improvement of the elastic recovery suggested that EPDM-g-PI copolymers can create a second network in the material, resulting in a higher apparent crosslinking density. The mechanical properties of the cured blend showed a doubling of Young's modulus and maximal stress compared to the pure matrix, as well as a constant strain at break.

It is noted that Charlotte Dubois et al. in “Innovative polypropylene based blends by in situ polymerization of a polyimide dispersed phase by reactive extrusion.” Polymer, 2022,254, pp. 125022. 10.1016/j.polymer.2022.125022. hal-03759559 describes the reactive extrusion of polyimide in a PP/PP-g-MA matrix. However, this document is silent regarding the use of grafted elastomers and the possibility of producing reinforced elastomer-polyimide blends.

Philippe Cassagnau et al. In “Experimental and modeling aspect of the reactive extrusion process”, DOI 10.1051/meca/2019052 also discusses reactive extrusion. However, this document is silent about the reinforcement of grafted elastomers.

One or more of the following can be used to further define the process according to the first aspect:

According to the disclosure, in step (a) of the process, the grafted elastomer (such as the grafted ethylene-propylene-diene monomer (EPDM) elastomer) is provided at a content of at least 60 wt. % based on the total weight of the components; preferably at a content ranging from 60 to 97 wt. %; more preferably from 62 to 95 wt. %; even more preferably, from 65 to 92 wt. %; most preferably from 70 to 90 wt. %.

With preference, the polyimide of the elastomer-polyimide blend is present at a content from 3 to 40 wt. % based on the total weight of the reinforced elastomeric material; preferably from 3 to less than 35 wt. % or from 35 wt. % to 40 wt. %. In one embodiment, the reinforced elastomeric material comprises an elastomeric matrix phase and from 3 to less than 35 wt. % of a polyimide phase based on the total weight of the reinforced elastomeric material and the polyimide phase is present in the form of dispersed nodules with an average diameter of less than 1000 nm as determined by TEM; preferably, ranging from 20 nm to 980 nm; more preferably ranging from 30 nm to 850 nm; and even more preferably ranging from 50 nm to 600 nm; most preferably ranging from 80 nm to 500 nm; even most preferably, from 100 nm to 400 nm, or from 110 nm to 300 nm, or from 120 nm to 250 nm, or from 130 nm to 240 nm.

For example, the average diameter of the polyimide nodules ranges from 20 to 980 nm as determined by TEM; more preferably ranging from 30 to 850 nm; and even more preferably ranging from 50 to 600 nm; most preferably ranging from 80 to 500 nm; even most preferably, from 100 to 400 nm or from 110 to 300 nm or from 120 to 250 nm.

In an alternative embodiment, the reinforced elastomeric material comprises an elastomeric matrix phase and from at least 35 wt. %, of a polyimide phase based on the total weight of the reinforced elastomeric material, or from 35 wt. % to 50 wt. %, or from 38 wt. % to 48 wt. %, or from 40 wt. % to 45 wt. %, or from 40 wt. % to 50 wt. %; and wherein the elastomeric matrix phase and the polyimide phase are co-continuous phase and/or the polyimide phase is present in the form of dispersed nodules with an average diameter of at least 1000 nm as determined by TEM.

For example, the reinforced elastomeric material comprises an elastomeric matrix phase and a polyimide phase which are co-continuous phases.

For example, the reinforced elastomeric material comprises an elastomeric matrix phase and more than 35 wt. % to 40 wt. % of a polyimide phase based on the total weight of the reinforced elastomeric material and the elastomeric matrix phase and the polyimide phase are co-continuous phases.

### The Grafting Agent

For example, the grafted elastomer comprises from 0.1 to 10.0 wt. % of a grafting agent based on the total weight of the grafted elastomer; preferably, from 0.2 to 6.0 wt. %; more preferably, from 0.3 to 5.0 wt. %; even more preferably, from 0.5 to 3.0 wt. %; and most preferably from 0.8 to 2.0 wt. %. The content of the grafting agent can be determined by titration.

For example, the grafted elastomer comprises a grafting agent. With preference, the grafting agent comprises or is one or more functional monomers selected from maleic anhydride (MAH), glycidyl methacrylate (GMA), methyl methacrylate (MMA), acrylic acid (AAc), butyl acrylate (BA), vinyl acetate (VA), diethyl maleate (DEM), acrylamide (AAm), and any mixture thereof. More preferably, the grafting agent is or comprises maleic anhydride (MAH).

### The Elastomer of the Grafted Elastomer

For example, the elastomer of the grafted elastomer is selected from natural rubber (NR), epoxidized natural rubber (ENA), styrene-butadiene rubber (SBR), nitrile rubber (NBR), chloroprene rubber (CR), ethylene propylene rubber (EPR), ethylene-propylene-diene monomer (EPDM) elastomer, butyl rubber (IIR), chlorobutyl rubber (CIlR), acryl rubber (ACM), silicone rubber (Q), fluorine-containing rubber (FKM), butadiene rubber (BR), epoxidized butadiene rubber (EBR), epichlorohydrin rubber (CO, CEO), urethane rubber (U), and polysulfide rubber (T), ethylene-octene copolymer (EOC), thermoplastic elastomers such as olefin-based elastomers (TPO), poly(vinyl chloride)-based elastomers (TPVC), polyester-based elastomers (TPEE), polyurethane-based elastomers (TPU), polyamide-based elastomers (TPEA), and polystyrene-based elastomers (SBS); and mixtures thereof. With preference, the elastomer of the grafted elastomer is or comprises ethylene-propylene-diene monomer (EPDM) elastomer, ethylene-octene copolymer (EOC) and a mixture thereof. More preferably, the elastomer of the grafted elastomer is or comprises ethylene-propylene-diene monomer (EPDM) elastomer. In a preferred embodiment, the elastomer of the grafted elastomer is or comprises ethylene-propylene-diene monomer (EPDM) elastomer and/or the grafted elastomer is ethylene-propylene-diene monomer elastomer grafted with maleic anhydride functions (EPDM-g-MA).

In an embodiment, the elastomer of the grafted elastomer is or comprises ethylene-propylene-diene monomer (EPDM) elastomer and the grafted EPDM elastomer has a diene content ranging from 1.0 to 3.0 mol. % as determined by ¹H NMR; with preference from 1.5 to 2.5 mol. %.

In an embodiment, the elastomer of the grafted elastomer is or comprises ethylene-propylene-diene monomer (EPDM) elastomer and the grafted EPDM elastomer has an ethylene content ranging from 40 to 75 mol. % based on the total molar content of the grafted EPDM elastomer as determined by ¹H NMR; with preference from 50 to 70 mol. %.

In an embodiment, the elastomer of the grafted elastomer is or comprises ethylene-propylene-diene monomer (EPDM) elastomer and the grafted EPDM elastomer has a number average molecular weight Mn ranging from 50,000 to 250,000 g/mol as determined by size-exclusion chromatography; with preference from 50,000 to 100,000 g/mol.

### The One or More Dianhydrides

In a preferred embodiment, the one or more dianhydrides provided at step (a) are selected from one or more aromatic dianhydrides, one or more aliphatic dianhydrides, and any mixture thereof; preferably, the one or more dianhydrides provided at step (a) are or comprise one or more aromatic dianhydrides.

For example, the one or more dianhydrides provided at step (a) are selected from pyromellitic dianhydride (PMDA) 3,3′,4,4′-benzophenone tetracarboxylic dianhydride (BTDA), 3,3′,4,4′-biphenyl tetracarboxylic dianhydride (BPDA), 1S,2R,4S,5R-cyclohexanetetracarboxylic dianhydride (H-PMDA), 1,2,3,4-cyclobutanetetracarboxylic dianhydride (CBDA), bicyclo-[2.2.2]oct-7-ene-2-exo,3-exo,5-exo,6-exo-2,3:5,6-dianhydride (BTA), and any mixture thereof.

With preference, the one or more aromatic dianhydrides are or comprise pyromellitic dianhydride (PMDA), 3,3′,4,4′-benzophenone tetracarboxylic dianhydride (BTDA), 3,3′,4,4′-biphenyl tetracarboxylic dianhydride (BPDA), and any mixture thereof, more preferably pyromellitic dianhydride (PMDA), 3,3′,4,4′-benzophenone tetracarboxylic dianhydride (BTDA), and any mixture thereof.

With preference, the one or more aliphatic dianhydrides are or comprise 1S,2R,4S,5R-cyclohexanetetracarboxylic dianhydride (H-PMDA), 1,2,3,4-cyclobutanetetracarboxylic dianhydride (CBDA), bicyclo-[2.2.2]oct-7-ene-2-exo,3-exo,5-exo,6-exo-2,3:5,6-dianhydride (BTA), and any mixture thereof. More preferably the one or more aliphatic dianhydrides are or comprise 1,2,3,4-cyclobutanetetracarboxylic dianhydride (CBDA), bicyclo-[2.2.2]oct-7-ene-2-exo,3-exo,5-exo,6-exo-2,3:5,6-dianhydride (BTA), and any mixture thereof

### The One or More Diamines

In an embodiment, one or more diamines provided at step (a) are one or more branched aliphatic diamines. With preference, the one or more branched aliphatic diamines are selected from trimethyl hexamethylenediamine (TMD), methyl pentamethylenediamine (MPMD), and methyl octamethylenediamine (MOMD). More preferably the one or more branched aliphatic diamines are or comprise trimethyl hexamethylenediamine (TMD).

### The Two or More Reverse Conveying Elements

In a preferred embodiment, the two or more reverse conveying elements are selected from kneading left-handed element and/or left-handed elements; with preference, the two or more hot zones comprise a first hot zone with successive kneading blocks elements over a length of at least 4 D followed by a left-handed element, with D being the screw diameter, and one or more additional hot zones placed downstream of the first hot zone, said one or more additional hot zones being filled mixing zones, each comprising kneading blocks elements over a length of at least 4 D followed by a kneading left-handed element or by a left-handed element, with D being the screw diameter.

### The Polyimide of the Elastomer-Polyimide Blend

In an embodiment, the polyimide of the elastomer-polyimide blend recovered at step (c) is an aliphatic-aromatic polyimide.

In an embodiment, the polyimide of the elastomer-polyimide blend recovered at step (c) has a glass temperature transition (T_{g}) of at least 100° C. as determined by DSC; preferably of at least 110° C.; more preferably of at least 120° C.; even more preferably of at least 130° C. or at least 135° C., or at least 140° C.

For example, the polyimide of the elastomer-polyimide blend recovered at step (c) has a glass temperature transition (T_{g}) ranging from 100° C. to 250° C. as determined by DSC; preferably ranging from 110° C. to 240° C.; more preferably ranging from 120° C. to 230° C.; more preferably ranging from 130° C. to 220° C.; even more preferably, from 135° C. to 210° C.; most preferably ranging from 140° C. to 200° C.; and even most preferably from 150° C. to 200° C.

### The Reinforced Elastomeric Material

In an embodiment, the reinforced elastomeric material is crosslinked and the process further comprises a step (d) of crosslinking the elastomer-polyimide blend recovered at step (c) by the addition from 1.0 to 25.0 wt. % of a crosslinking agent based on the total weight of the elastomer-polyimide blend, or from 1.0 to 20.0 wt. %, or from 1.0 to 15.0 wt. %, or from 1.0 to 10.0 wt. %.

According to the disclosure, the reinforced elastomeric material is devoid of reinforcing material selected from silica and/or carbon black; or comprises one or more reinforcing elements selected from carbon black and/or silica wherein one or more reinforcing elements are present at a content of at most 2.0 wt. % based on the total weight of the reinforced elastomeric material.

For example, the crosslinking agent comprises one or more peroxides, one or more phenolic resins, sulfur, or a mixture thereof, more preferably one or more peroxides.

With preference, the crosslinking agent is or comprises dicumyl peroxide.

According to a second aspect, the disclosure provides a reinforced elastomeric material remarkable in that it comprises an elastomeric matrix phase and a polyimide phase wherein the polyimide of the polyimide phase has a glass temperature transition (Tg) ranging from 100° C. to 250° C. as determined by DSC and is present in a content of from 3 to 40 wt. % of a based on the total weight of the reinforced elastomeric material; with preference, the polyimide of the polyimide phase is an aliphatic-aromatic polyimide.

One or more of the following can be used to further define the reinforced elastomeric material according to the second aspect:

The reinforced elastomeric material is a reinforced ethylene-propylene-diene elastomer.

For example, the polyimide phase has a glass temperature transition (T_{g}) of at least 110° C. as determined by DSC; preferably of at least 120° C.; more preferably of at least 130° C.; even more preferably of at least 135° C. or at least 140° C.

For example, the polyimide phase has a glass temperature transition (T_{g}) ranging from 110° C. to 240° C. as determined by DSC; preferably ranging from 120° C. to 250° C.; more preferably ranging from 120° C. to 230° C.; more preferably ranging from 130° C. to 220° C.; even more preferably, from 135° C. to 210° C.; most preferably ranging from 140° C. to 200° C.; and even most preferably from 150° C. to 200° C.

In one embodiment, the reinforced elastomeric material comprises an elastomeric matrix phase and from 3 to less than 35 wt. % of a polyimide phase based on the total weight of the reinforced elastomeric material and the polyimide phase is present in the form of dispersed nodules with an average diameter of less than 1000 nm as determined by TEM; preferably, ranging from 20 nm to 980 nm; more preferably ranging from 30 nm to 850 nm; and even more preferably ranging from 50 nm to 600 nm; most preferably ranging from 80 nm to 500 nm; even most preferably, from 100 nm to 400 nm, or from 110 nm to 300 nm, or from 120 nm to 250 nm, or from 130 nm to 240 nm.

With preference, the reinforced elastomeric material comprises an EPDM matrix phase and from 3 to less than 35 wt. % of a polyimide phase based on the total weight of the reinforced ethylene-propylene-diene elastomer, wherein the polyimide phase is present in the form of dispersed nodules with an average diameter of less than 1000 nm as determined by TEM and wherein the reinforced ethylene-propylene-diene elastomer shows one or more selected from:
a young modulus ranging from 5 to less than 250 MPa;
a maximal stress ranging from 1 to less than 8 MPa;
a stress at break ranging from 0.7 to less than 6 MPa;
a strain at break of more than 10 to 100%,
an equilibrium shear modulus ranging from 0.4×10⁵ to 1.6×10⁶ Pa wherein the equilibrium shear modulus is measured at 130° C. and is defined as

$${G}_{e} = {lim}_{ω \to 0} {G}^{′} ( ω ) ;$$

with preference ranging from 0.6×10⁵ to 1.1×10⁶ Pa.

In an alternative embodiment, the reinforced elastomeric material comprises an elastomeric matrix phase and from at least 35 wt. %, of a polyimide phase based on the total weight of the reinforced elastomeric material, or from 35 wt. % to 40 wt. %; and wherein the elastomeric matrix phase and the polyimide phase are co-continuous phase and/or the polyimide phase is present in the form of dispersed nodules with an average diameter of at least 1000 nm as determined by TEM.

For example, the reinforced elastomeric material comprises an elastomeric matrix phase and at least 35 wt. % of a polyimide phase based on the total weight of the reinforced elastomeric material and in that the elastomeric matrix phase, preferably an EPDM matrix phase, and the polyimide phase are co-continuous phases.

With preference, the reinforced ethylene-propylene-diene elastomer comprises an EPDM matrix phase and at least 35 wt. % of a polyimide phase based on the total weight of the reinforced ethylene-propylene-diene elastomer, wherein the EPDM matrix phase and the polyimide phase are co-continuous phases, and wherein reinforced ethylene-propylene-diene elastomer shows one or more selected from:
a young modulus of at least 250 MPa;
a maximal stress of at least 8 MPa;
a stress at break of at least 6 MPa;
a strain at break of less than 10%;
an equilibrium shear modulus ranging from 0.4×10⁵ to 1.6×10⁶ Pa wherein the equilibrium shear modulus is measured at 130° C. and is defined as

$${G}_{e} = {lim}_{ω \to 0} {G}^{′} ( ω ) ;$$

with preference ranging from 0.6×10⁵ to 1.1×10⁶ Pa.

In an embodiment, the reinforced elastomeric material is a cross-linked material.

According to the disclosure, the reinforced elastomeric material is devoid of reinforcing material selected from silica and/or carbon black; or comprises one or more reinforcing elements selected from carbon black and/or silica wherein one or more reinforcing elements are present at a content of at most 2.0 wt. % based on the total weight of the reinforced elastomeric material. For example, the reinforced elastomeric material has been produced by the process according to the first aspect.

### DESCRIPTION OF THE FIGURES

FIG. 1 represents the chemical structure of the synthesized polyimide.

FIG. 2 is an example of a twin-screw profile with two reverse conveying elements.

FIG. 3 represents the copolymer structure resulting from the reaction between EPDM-g-MA and PI.

FIG. 4 are TEM images of EPDM-g-MA/PI blends a): 90/10 (weight ratio), b): 80/20 (weight ratio), c) 60/40 (weight ratio) (PI phase=black domain).

FIG. 5 represents the tensile curves of the in situ EPDM-g-MA/PI blends for different concentrations of PI.

FIG. 6 represents the variation of the storage and loss modulus of EPDM-g-MA/PI blends at (a): 130° C. (PI is a solid phase) and (b): 200° C.

FIG. 7 represents the variation of the storage and loss modulus of EPDM-g-MA/PI 80/20 (weight ratio) at 130° C. and 200° C.

FIG. 8 represents the linear behavior of EPDM-g-MA/PI in situ blends represented as G′/GO at (a): 130° C. (PI is a solid phase) and (b): 200° C.

FIG. 9 represents the tensile curves of EPDM-g-MA/PI 80/20 (weight ratio) without DCP and with 2 wt. % of DCP based on the total weight of the elastomer-polyimide blend.

FIG. 10 represents the linear behavior of EPDM-g-MA/PI/DCP blends represented as G′/GO at (a): 130° C. and (b): 200° C.

FIG. 11 represents the storage and loss modulus of EPDM-g-MA/PI/blends at (a): 130° C. and (b): 200° C. under air.

### DETAILED DESCRIPTION

For the disclosure, the following definitions are given:

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g. 1 to 5 can include 1, 2, 3, 4, 5 when referring to, for example, a number of elements, and can also include 1.5, 2, 2.75 and 3.80, when referring to, for example, measurements). The recitation of endpoints also includes the recited endpoint values themselves (e.g. from 1.0 to 5.0 includes both 1.0 and 5.0). Any numerical range recited herein is intended to include all sub-ranges subsumed therein.

The term “EPDM” refers to ethylene propylene diene monomer elastomers and is used herein to mean any elastomer that is a terpolymer of ethylene, an alpha-olefin having from 3 to 10 carbon atoms, and a copolymerizable non-conjugated diene such as 5-ethylidene-2-norbornene, dicyclopentadiene, butadiene, and the like.

The term “NMR” stands for nuclear magnetic resonance.

The disclosure provides a process to produce a reinforced elastomeric material remarkable in that it comprises:
a) providing components comprising a grafted elastomer, one or more dianhydrides, and one or more diamines; wherein the grafted elastomer is provided at a content of at least 60 wt. % based on the total weight of the components;
b) performing in situ synthesis of a polyimide phase in the grafted elastomer by reactive extrusion of the components in a twin-screw extruder comprising a main hopper wherein the screw profile comprises two or more reverse conveying elements forming two or more hot zones to form an elastomer-polyimide blend; and
c) recovering said elastomer-polyimide blend being a reinforced elastomeric material wherein the polyimide of the elastomer-polyimide blend is present at a content from 3 to 40 wt. % based on the total weight of the reinforced elastomeric material.

According to the disclosure, the reinforced elastomeric material is devoid of reinforcing material selected from silica and/or carbon black and the process material is devoid of a step of adding one or more reinforcing material selected from silica and/or carbon black.

Alternatively, step a) comprises providing one or more reinforcing elements selected from carbon black and/or silica in addition to the other components wherein one or more reinforcing elements are provided at a content of at most 2.0 wt. % based on the total weight of the components; preferably at most 1.5 wt. %; more preferably at most 1.0 wt. %; even more preferably at most 0.5 wt. %, and most preferably at most 0.1 wt. %.

In such a case, the reinforced elastomeric material comprises one or more reinforcing elements selected from carbon black and/or silica wherein one or more reinforcing elements are present at a content of at most 2.0 wt. % based on the total weight of the reinforced elastomeric material; preferably at most 1.5 wt. %; more preferably at most 1.0 wt. %; even more preferably at most 0.5 wt. %, and most preferably at most 0.1 wt. %.

In a preferred embodiment, the elastomer is ethylene-propylene-diene monomer (EPDM) elastomer and the disclosure provides a process to produce a reinforced ethylene-propylene-diene elastomer remarkable in that it comprises:
a) providing components comprising a grafted ethylene-propylene-diene monomer (EPDM) elastomer, one or more dianhydrides, and one or more diamines; wherein the grafted EPDM elastomer is provided at a content of at least 60 wt. % based on the total weight of the components;
b) performing in situ synthesis of a polyimide phase in the grafted EPDM elastomer by reactive extrusion of the components in a twin-screw extruder comprising a main hopper wherein the screw profile comprises two or more reverse conveying elements forming two or more hot zones to form an EPDM-polyimide blend; and
c) recovering an EPDM-polyimide blend being a reinforced EPDM elastomer wherein the polyimide of the elastomer-polyimide blend is present at a content from 3 to 40 wt. % based on the total weight of the reinforced elastomeric material.

The reinforced elastomeric material (such as the reinforced EPDM elastomeric material) and the process to produce it will be described jointly.

According to the disclosure, in step (a) of the process, the grafted elastomer (such as the grafted ethylene-propylene-diene monomer (EPDM) elastomer) is provided at a content of at least 50 wt. % based on the total weight of the components; preferably at a content ranging from 50 to 97 wt. %; more preferably from 52 to 95 wt. %; even more preferably, from 55 to 92 wt. %; most preferably from 60 to 90 wt. %.

With preference, in step (a) of the process, the grafted elastomer (such as the grafted ethylene-propylene-diene monomer (EPDM) elastomer) is provided at a content of at least 60 wt. % based on the total weight of the components; preferably at a content ranging from 60 to 97 wt. %; more preferably from 62 to 95 wt. %; even more preferably, from 65 to 92 wt. %; most preferably from 70 to 90 wt. %.

With preference, the in situ synthesis of a polyimide in the grafted elastomer is performed by adding stoichiometric amounts of dianhydride and diamine.

Polyimides are high-performance polymers with high mechanical strength, they have high glass transition temperatures (T_{g}: 100 to 350° C.) which allows for keeping the reinforcement properties at high temperatures.

In a preferred embodiment, the two or more reverse conveying elements are selected from kneading left-handed elements and/or left-handed elements.

For example, the two or more hot zones comprise a first hot zone comprises successive kneading blocks elements over a length of at least 4 D followed by a left-handed element with D being the screw diameter, and one or more additional hot zones placed downstream of the first hot zone and being filled mixing zones, each comprising kneading blocks elements over a length of at least 4 D followed by a kneading left-handed element or by a left-handed element with D being the screw diameter.

In an embodiment, step (b) of performing in situ synthesis of a polyimide phase in the grafted EPDM elastomer by reactive extrusion comprises introducing the grafted EPDM elastomer and the dianhydride in the main hopper of the twin-screw extruder and injecting the diamine downstream the first reverse conveying element forming the first hot zone; with preference, at least one additional reverse conveying element forming an additional hot zone is placed at two-thirds of the screw length.

For example, step (b) comprises performing the reactive extrusion with a residence time of less than 10 minutes such as ranging from 10 seconds to less than 10 minutes; preferably with a residence time ranging from 15 seconds to 8 minutes; or with a residence time ranging from 20 seconds to 5 minutes; more preferably with a residence time ranging from 10 to 240 seconds; even more preferably, from 20 to 180 seconds; most preferably, from 40 to 150 seconds; and even most preferably, from 60 to 120 seconds.

For example, step (b) comprises performing the reactive extrusion at a temperature ranging from 150 to 250° C.; preferably from 180 to 230° C. These temperatures are the barrel temperatures.

### As Regards the Grafted Elastomer

For example, the grafted elastomer comprises from 0.1 to 10.0 wt. % of a grafting agent based on the total weight of grafted elastomer; preferably, from 0.2 to 6.0 wt. %; more preferably, from 0.3 to 5.0 wt. %; even more preferably, from 0.5 to 3.0 wt. %; and most preferably from 0.8 to 2.0 wt. %. It is understood that the grafting agent content represents the grafted content as determined by titration and does not include the unreacted grafting agent. In other words, the grafting agent content determination is performed after purification as described in the methods. Purification can include a venting procedure performed at the end of the extruder.

For example, the grafting agent comprises or consists of one or more functional monomers selected from maleic anhydride (MAH), glycidyl methacrylate (GMA), methyl methacrylate (MMA), acrylic acid (AAc), butyl acrylate (BA) vinyl acetate (VA), diethyl maleate (DEM), acrylamide (AAm), and any mixture thereof; with preference, the grafting agent is or comprises maleic anhydride (MAH).

For example, the elastomer is selected from natural rubber (NR), epoxidized natural rubber (ENA), styrene-butadiene rubber (SBR), nitrile rubber (NBR), chloroprene rubber (CR), ethylene propylene rubber (EPR), ethylene-propylene-diene monomer (EPDM) elastomer, butyl rubber (IIR), chlorobutyl rubber (CIlR), acryl rubber (ACM), silicone rubber (Q), fluorine-containing rubber (FKM), butadiene rubber (BR), epoxidized butadiene rubber (EBR), epichlorohydrin rubber (CO, CEO), urethane rubber (U), and polysulfide rubber (T), ethylene-octene copolymer (EOC); thermoplastic elastomers such as olefin-based elastomers (TPO), poly(vinyl chloride)-based elastomers (TPVC), polyester-based elastomers (TPEE), polyurethane-based elastomers (TPU), polyamide-based elastomers (TPEA), and polystyrene-based elastomers (SBS); and mixtures thereof. With preference, the elastomer is or comprises ethylene-propylene-diene monomer (EPDM) elastomer, ethylene-octene copolymer (EOC) and a mixture thereof. More preferably, the elastomer of the grafted elastomer is or comprises ethylene-propylene-diene monomer (EPDM) elastomer.

In an embodiment, step (a) of providing a grafted elastomer comprises the sub-step of preparing said grafted elastomer by extrusion of an elastomer with a grafting agent.

In a preferred embodiment, the grafted elastomer is or comprises a grafted EPDM and/or the grafted elastomer is ethylene-propylene-diene monomer elastomer grafted with maleic anhydride functions (EPDM-g-MA).

In the embodiments wherein the grafted elastomer is or comprises a grafted EPDM, the grafted EPDM elastomer is preferably selected to show one or more of the below-listed properties; more preferably all the below-listed properties:
an ethylene content ranging from 40 to 75 mol. % based on the total molar content of the grafted EPDM elastomer as determined by ¹H NMR; with preference from 50 to 70 mol. %;
a propylene content ranging from 22 to 59 mol. % based on the total molar content of the grafted EPDM elastomer as determined by ¹H NMR; with preference from 28 to 49 mol. %;
a diene content ranging from 1.0 to 3.0 mol. % as determined by ¹H NMR; with preference from 1.5 to 2.5 mol. %;
a number average molecular weight (Mn) ranging from 40,000 to 250,000 g/mol as determined by size-exclusion chromatography; with preference from 50,000 to 120,000 g/mol; and
a weight average molecular weight (Mw) ranging from 130,000 to 350,000 as determined by size-exclusion chromatography; with preference from 170,000 to 280,000 g/mol.

### As Regards the One or More Dianhydrides

In a preferred embodiment, one or more dianhydrides provided at step (a) are aromatic dianhydrides and/or one or more aliphatic dianhydrides, more preferably one or more aromatic dianhydrides. Indeed, the aromatic dianhydrides will lead to a polyimide phase which has higher T_{g} and a better thermal resistance.

For example the one or more aromatic dianhydrides are selected from 1,2,5,6-naphthalene tetracarboxylic dianhydride, 1,4,5,8-naphthalene tetracarboxylic dianhydride, 2,3,6,7-naphthalene tetracarboxylic dianhydride, 2-(3′,4′-dicarboxyphenyl) 5,6-dicarboxybenzimidazole dianhydride, 2-(3′,4′-dicarboxyphenyl) 5,6-dicarboxybenzoxazole dianhydride, 2-(3′,4′-dicarboxyphenyl) 5,6-dicarboxybenzothiazole dianhydride, 2,2′,3,3′-benzophenone tetracarboxylic dianhydride, 3,3′,4,4′-benzophenone tetracarboxylic dianhydride (BTDA), 2,2′,3,3′-biphenyl tetracarboxylic dianhydride, 2,3,3′,4′-biphenyl tetracarboxylic dianhydride, 3,3′,4,4′-biphenyl tetracarboxylic dianhydride (BPDA), bicyclo-[2,2,2]-octen-(7)-2,3,5,6-tetracarboxylic-2,3,5,6-dianhydride, 4,4′-thio-diphthalic anhydride, bis(3,4-dicarboxyphenyl) sulfone dianhydride, bis (3,4-dicarboxyphenyl) sulfoxide dianhydride (DSDA), bis(3,4-dicarboxyphenyl oxadiazole-1,3,4) p-phenylene dianhydride, bis(3,4-dicarboxyphenyl) 2,5-oxadiazole 1,3,4-dianhydride, bis 2,5-(3′,4′-dicarboxydiphenylether) 1,3,4-oxadiazole dianhydride, 4,4′-oxydiphthalic anhydride (ODPA), bis(3,4-dicarboxyphenyl) thio ether dianhydride, bisphenol A dianhydride (BPADA), bisphenol S dianhydride, 2,2-bis-(3,4-dicarboxyphenyl) 1,1,1,3,3,3,-hexafluoropropane dianhydride (6FDA), 5,5-[2,2,2]-trifluoro-1-(trifluoromethyl)ethylidene, bis-1,3-isobenzofurandione, 1,4-bis(4,4′-oxyphthalic anhydride) benzene, bis(3,4-dicarboxyphenyl) methane dianhydride, cyclopentadienyl tetracarboxylic acid dianhydride, perylene 3,4,9,10-tetracarboxylic dianhydride, pyromellitic dianhydride (PMDA), 1,3-bis-(4,4′-oxydiphthalic anhydride) benzene, 2,2-bis(3,4-dicarboxyphenyl) propane dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, pyrazine-2,3,5,6-tetracarboxylic dianhydride, benzene-1,2,3,4-tetracarboxylic dianhydride; and thiophene-2,3,4,5-tetracarboxylic dianhydride.

With preference, the one or more aromatic dianhydrides provided at step a) are or comprise pyromellitic dianhydride (PMDA), 3,3′,4,4′-benzophenone tetracarboxylic dianhydride (BTDA), 3,3′,4,4′-biphenyl tetracarboxylic dianhydride (BPDA), and any mixture thereof.

In a preferred embodiment, the one or more aromatic dianhydrides provided at step (a) are or comprise pyromellitic dianhydride (PMDA), 3,3′,4,4′-benzophenone tetracarboxylic dianhydride (BTDA), and any mixture thereof.

For example, the one or more dianhydrides provided at step (a) are selected from pyromellitic dianhydride (PMDA) 3,3′,4,4′-benzophenone tetracarboxylic dianhydride (BTDA), 3,3′,4,4′-biphenyl tetracarboxylic dianhydride (BPDA), 1S,2R,4S,5R-cyclohexanetetracarboxylic dianhydride (H-PMDA), 1,2,3,4-cyclobutanetetracarboxylic dianhydride (CBDA), bicyclo-[2.2.2]oct-7-ene-2-exo,3-exo,5-exo,6-exo-2,3:5,6-dianhydride (BTA), and any mixture thereof.

With preference, the one or more aliphatic dianhydrides are or comprise 1S,2R,4S,5R-cyclohexanetetracarboxylic dianhydride (H-PMDA), 1,2,3,4-cyclobutanetetracarboxylic dianhydride (CBDA), bicyclo-[2.2.2]oct-7-ene-2-exo,3-exo,5-exo,6-exo-2,3:5,6-dianhydride (BTA), and any mixture thereof. More preferably the one or more aliphatic dianhydrides are or comprise 1,2,3,4-cyclobutanetetracarboxylic dianhydride (CBDA), bicyclo-[2.2.2]oct-7-ene-2-exo,3-exo,5-exo,6-exo-2,3:5,6-dianhydride (BTA), and any mixture thereof. The dianhydrides are commercially available at Sigma-Aldrich.

### As Regards the One or More Diamines

In an embodiment, one or more diamines provided at step (a) are branched aliphatic diamines. For example, the one or more branched aliphatic diamines are selected from trimethyl hexamethylenediamine (TMD), methyl pentamethylenediamine (MPMD), and methyl octamethylenediamine (MOMD). More preferably the one or more branched aliphatic diamines are or comprise trimethyl hexamethylenediamine (TMD). These branched aliphatic diamines are commercially available at large scale and their toxicity is relatively low.

As well known by the person skilled in the art, trimethyl hexamethylenediamine is a mixture of two isomers of trimethyl-1,6-hexanediamine; i.e., it is a mixture of (2,2,4) and (2,4,4) trimethyl hexanemethylenediamine.

### As Regards the Elastomer-Polyimide Blend and the Reinforced Elastomeric Material

The disclosure further provides a reinforced elastomeric material remarkable in that it comprises an elastomeric matrix phase and a polyimide phase wherein the polyimide of the polyimide phase has a glass temperature transition (T_{g}) of at least 100° C. as determined by DSC, or at least 120° C., or at least 135° C., and is present in a content of from 3 to 40 wt. % of a based on the total weight of the reinforced elastomeric material.

In a preferred embodiment, the elastomer is ethylene-propylene-diene elastomer, and the reinforced ethylene-propylene-diene elastomer (EPDM) is remarkable in that it comprises an EPDM matrix phase and a polyimide phase wherein the polyimide of the polyimide phase has a glass temperature transition (T_{g}) of at least 100° C. as determined by DSC and is present in a content of from 3 to 40 wt. % of a based on the total weight of the reinforced EPDM.

With preference, the polyimide of the polyimide phase (i.e., in the elastomer-polyimide blend recovered at step (c)) has a glass temperature transition (Tg) of at least 110° C. as determined by DSC; preferably of at least 120° C.; more preferably of at least 130° C.; even more preferably of at least 135° C. or at least 140° C.

For example, the polyimide of the polyimide phase has a glass temperature transition (Tg) ranging from 100° C. to 250° C. as determined by DSC; preferably ranging from 110° C. to 240° C.; more preferably ranging from 120° C. to 230° C.; more preferably ranging from 130° C. to 220° C.; even more preferably, from 135° C. to 210° C.; most preferably ranging from 140° C. to 200° C.; and even most preferably from 150° C. to 200° C.

In a preferred embodiment, the polyimide of the polyimide phase (i.e., in the elastomer-polyimide blend recovered at step (c)) is an aliphatic-aromatic polyimide. Such aliphatic-aromatic polyimide is obtained using aromatic dianhydrides and aliphatic diamines when producing the polyimide. The use of aliphatic-aromatic polyimide in the reinforced elastomeric material is favorable for thermal resistance.

The reinforced elastomeric material comprises an elastomeric matrix phase and a polyimide phase which are co-continuous phases, or an elastomeric matrix phase and a polyimide phase wherein the polyimide phase is present in the form of dispersed nodules with an average diameter of less than 1000 nm as determined by TEM; with preference ranging from 80 to 500 nm.

In an embodiment, the reinforced elastomeric material is crosslinked and the process further comprises a step (d) of crosslinking the elastomer-polyimide blend recovered at step (c) by the addition of from 1.0 to 25.0 wt. % of a crosslinking agent based on the total weight of the elastomer-polyimide blend, or from 1.0 to 20.0 wt. %, or from 1.0 to 15.0 wt. %, or from 1.0 to 10.0 wt. %.

For example, the crosslinking agent comprises one or peroxide, one or more phenolic resins, sulfur or a mixture thereof, more preferably one or more peroxide.

For example, the crosslinking agent comprises at least one of di-tert-butyl peroxide, dicumyl peroxide, tert-butyl cumyl peroxide, 1,1-di-tert-butyl peroxide-3,3,5-trimethylcyclohexane, 2,5-dimethyl-2,5-di(tert-butylperoxy) hexane, 2,5-dimethyl-2,5-di(tert-butylperoxy) hexyne-3, bis(tert-butylperoxyisopropyl) benzene, 2,5-dimethyl-2,5-bis(benzoylperoxy) hexane, tert-butyl peroxybenzoate, and tert-butylperoxy-2-ethylhexyl carbonate. With preference, the crosslinking agent is or includes dicumyl peroxide.

In a preferred embodiment, the reinforced elastomeric material comprises an elastomer-polyimide copolymer.

For example, the reinforced elastomeric material comprises a copolymer whose the structure is depicted on FIG. 3.

For example, polyimide is present in the reinforced elastomeric material, such as in the reinforced EPDM elastomer, at a content of from 3 to 50 wt. % of a based on the total weight of the reinforced elastomeric material; preferably from 5 to 45 wt. %; more preferably from 8 to 42 wt. % and even more preferably from 10 to 40 wt. %. The content of polyimide in the reinforced elastomeric material can be determined by ¹³C-NMR.

In a preferred embodiment, polyimide is present in the reinforced elastomeric material, such as in the reinforced EPDM elastomer, at a content of from 3 to 40 wt. % of a based on the total weight of the reinforced elastomeric material; preferably from 5 to 38 wt. %; more preferably from 8 to 35 wt. % and even more preferably from 10 to 32 wt. %.

It has been found that the content of polyimide in the reinforced elastomeric material could lead either to a dispersed phase wherein polyimide is present as dispersed nodules in the elastomeric matrix or as a co-continuous phase.

For example, the reinforced elastomeric material comprises an elastomeric matrix phase and from 3 to 35 wt. % of a polyimide phase based on the total weight of the reinforced elastomeric material and the polyimide phase is present in the form of dispersed nodules with an average diameter of less than 1000 nm as determined by TEM; preferably, ranging from 20 to 980 nm; more preferably ranging from 30 to 850 nm; and even more preferably ranging from 50 to 600 nm; most preferably ranging from 80 to 500 nm; even most preferably, from 100 to 400 nm or from 110 to 300 nm or from 120 to 250 nm or from 130 to 240 nm.

In an embodiment, the reinforced ethylene-propylene-diene elastomer comprises an EPDM matrix phase and from 3 to 35 wt. % of a polyimide phase based on the total weight of the reinforced ethylene-propylene-diene elastomer and in that the polyimide phase is present in the form of dispersed nodules with an average diameter of less than 1000 nm as determined by TEM; preferably, polyimide (i.e. the polyimide phase) is present at a content ranging from 5 to 30 wt. % based on the total weight of the reinforced elastomeric material; more preferably from 8 to 25 wt. % and most preferably from 10 to 20 wt. %.

For example, the average diameter of the polyimide nodules is ranging from 20 to 980 nm as determined by TEM; more preferably ranging from 30 to 850 nm; and even more preferably ranging from 50 to 600 nm; most preferably ranging from 80 to 500 nm; even most preferably, from 100 to 400 nm or from 110 to 300 nm or from 120 to 250 nm or from 130 to 240 nm.

With preference, the reinforced ethylene-propylene-diene elastomer comprises an EPDM matrix phase and from 3 to 35 wt. % of a polyimide phase based on the total weight of the reinforced ethylene-propylene-diene elastomer, wherein the polyimide phase is present in the form of dispersed nodules with an average diameter of less than 1000 nm as determined by TEM and wherein the reinforced ethylene-propylene-diene elastomer shows one or more selected from:
a young modulus ranging from 5 to less than 250 MPa;
a maximal stress ranging from 1 to less than 8 MPa;
a stress at break ranging from 0.7 to less than 6 MPa;
a strain at break of more than 10 to 100%
an equilibrium shear modulus ranging from 0.4×10⁵ to 1.6×10⁶ Pa wherein the equilibrium shear modulus is measured at 130° C. and is defined as

$${G}_{e} = {lim}_{ω \to 0} {G}^{′} ( ω ) ;$$

with preference ranging from 0.6×10⁵ to 1.1×10⁶ Pa.

In another embodiment, the reinforced elastomeric material comprises an elastomeric matrix phase and more than 35 wt. % to 40 wt. % of a polyimide phase based on the total weight of the reinforced elastomeric material and the elastomeric matrix phase and the polyimide phase are co-continuous phases.

For example, the reinforced ethylene-propylene-diene elastomer comprises an EPDM matrix phase and more than 35 wt. % to 40 wt. % of a polyimide phase based on the total weight of the reinforced ethylene-propylene-diene elastomer and the EPDM matrix phase and the polyimide phase are co-continuous phases.

With preference, the reinforced ethylene-propylene-diene elastomer comprises an EPDM matrix phase and more than 35 wt. % of a polyimide phase based on the total weight of the reinforced ethylene-propylene-diene elastomer, wherein the EPDM matrix phase and the polyimide phase are co-continuous phases, and wherein reinforced ethylene-propylene-diene elastomer shows one or more selected from:
a young modulus of at least 250 MPa;
a maximal stress of at least 8 MPa;
a stress at break of at least 6 MPa;
a strain at break of less than 10%
an equilibrium shear modulus ranging from 0.4×10⁵ to 1.6×10⁶ Pa wherein the equilibrium shear modulus is measured at 130° C. and is defined as

$${G}_{e} = {lim}_{ω \to 0} {G}^{′} ( ω ) ;$$

with preference ranging from 0.6×10⁵ to 1.1×10⁶ Pa.

Indeed, as shown by the examples, Young's modulus of EPDM-g-MA was doubled with 10 wt. % of polyimide in the blend, and it was multiplied by 74 compared to the pure matrix, to reach 280 MPa with 40 wt. % of polyimide.

The viscoelastic properties of the blends were examined, especially the strain-dependence of the storage modulus. The EPDM-g-MA/PI blends displayed a linear behavior of the storage modulus below and above polyimide's glass transition temperature. The blend containing 40 wt. % of polyimide showed more non-linear effect (Payne effect γc=1%) due to the co-continuity of both phases.

The elastomer-polyimide blend containing 20 wt. % of polyimide was crosslinked with dicumyl peroxide (DCP), and the gel fraction was similar to the one of pure crosslinked EPDM-g-MA, suggesting that the polyimide does not alter the formation of the crosslinked network. However, the swelling ratio was decreased in the presence of polyimide, due to the superposition of two networks: one from the crosslinked elastomer and one from the EPDM-g-PI copolymers. This double network led to a better elastic recovery, but a smaller linear domain compared to pure crosslinked EPDM-g-MA. The Young's modulus and the maximal stress of the crosslinked material with 20 wt. % of PI were doubled compared to the matrix, and the strain at break was stable.

The reinforced elastomeric material of the disclosure is devoid of reinforcing elements selected from silica and/or carbon black.

Alternatively, it may comprise one or more reinforcing elements selected from carbon black and/or silica wherein one or more reinforcing elements are present at a content of at most 2.0 wt. % based on the total weight of the components; preferably at most 1.5 wt. %; more preferably at most 1.0 wt. %; even more preferably at most 0.5 wt. %, and most preferably at most 0.1 wt. %.

### Methods of Characterization

Equilibrium modulus: The equilibrium modulus was determined according to the equation:

$${G}_{e} = {lim}_{ω \to 0} {G}^{′} ( ω ) .$$

So the equilibrium modulus should be determined by extrapolation of G′ variation to low frequencies, typically between 0.1 and 0.01 rad/s. In the present case, as the extrapolation was tricky, the equilibrium modulus was estimated at Ge=G′(ω=0.1 rad/s)

Gel fraction: The gel fraction was determined by immersing 150 mg (wi) of the material in 30 mL ox p-xylene at 110° C. for 48 h. The samples are weighed after drying at 50° C. for 24 h under a vacuum (wd). The gel fraction is calculated as follows:

$$G F = \frac{{w}_{d}}{{w}_{i}} \qquad Eq . 1$$

Swelling ratio: The total soluble fraction was extracted with p-xylene over 48 hours at 110° C. The swelling equilibrium is described as follows:

$$Se = 1 + \frac{{ρ}_{polymer}}{{ρ}_{solvent}} ( \frac{{m}_{s} - {m}_{i} \cdot {θ}_{p} - {m}_{d}}{{m}_{d}} ) ( \frac{1}{1 - {θ}_{f}} ) \qquad Eq . 2$$

With mi the initial mass of the sample, ms the swollen polymer mass, md the dry polymer mass, θp the polymer volume fraction in the compound and θf the filler volume fraction in the compound.

Transmission Electron Microscopy (TEM) observations were carried out on a Philips CM120 microscope using an acceleration voltage of 80 kV and under a high vacuum. A flat surface of specimens was obtained with an ultramicrotome UC7 Leica at −100° C. using a diamond knife (Diatome). Ultrathin sections of 80 nm were collected on a copper grid.

The average diameter of the nodules is then calculated on the TEM images using the ImageJ software.

Rheoloqical behavior: Dynamic frequency tests were conducted on a strain-controlled ARES G2 (TA Instruments) using a parallel plate geometry (8 mm diameter, 2 mm gap). Measurements were performed at 130° C. and 200° C. under nitrogen. The linear melt behavior was studied in the range of deformation 0.01-100% at a fixed frequency of 1 rad/s. The complex shear modulus was measured (storage modulus G′ (ω) and loss modulus G″(ω)) by varying the frequencies from 100 to 0.01 rad/s at a fixed strain of 1%.

Tensile properties: Uniaxial tensile tests were performed on a Shimadzu AG-X tensile testing machine equipped with a load cell of 10 kN at room temperature. Each blend was tested at a speed of 10 m/min to measure yield stress, strain at break and Young's modulus. At least 6 different samples were tested for each formulation.

Elastic recovery (compression set): The elastic recovery of the materials was determined according to the normalized test ISO 815-1. Disks of 13 mm in diameter with a thickness of 6 mm were placed in a metallic system imposing a strain of 25%. The system is placed in an oven at 100° C. for 24 hours. Once the deformation is removed, the thicknesses of the samples are measured after a relaxation time of 30 min at room temperature. The compression set value can be determined with the following equation:

$$Cs ( \% ) = \frac{1}{{ε}_{0}} ( 1 - \frac{{l}_{1}}{{l}_{0}} ) \times 100 \qquad Eq . 3$$

Where ε₀ is the deformation imposed (0.25), l0 the initial sample thickness and l1 the sample's thickness after 24 h of compression at 100° C. and then 30 min of relaxation at room temperature.

### Differential Scanning Calorimetry (DSC):

Thermal properties of the blends were characterized by differential scanning calorimetry (DSC) to study the melting and crystallization behavior using a model Q200 (TA Instruments) equipped with a cooling system 90. Indium was used as a calibration standard. 5 to 10 mg of the samples were weighed and placed into hermetic aluminium capsules. The value of the glass transition temperature (Tg) on the first cycle applied from 0° C. to 250° C. at a heating rate of 10° C./min under nitrogen.

### Determination of the MA Content (Titration)

Few grams of the grafted product are purified in a vacuum oven at 140° C. for 24 h, this step is crucial to remove all of the unreacted maleic acid by evaporation beyond the melting temperature of the polymer. This step is not needed when a venting procedure is performed at the end of the extruder.

The grafted maleic anhydride reacts with water hence forming the maleic acid form (diacid) which is optically active due to the presence of one asymmetric carbon in its molecule.

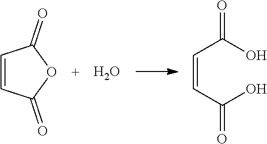 [SMILES: O=C1C=CC(=O)O1 ; O ; O=C(O)/C=C\C(=O)O]

### Hydrolysis of Maleic Anhydride to Form Maleic Acid

The MA content of the purified products is calculated from the acid number. 0.5 g of the grafted polymer with maleic anhydride are dissolved in xylene at 120° C. in a flask with high agitation for 30 min. Then water drops are added to the solution after lowering the temperature to c.a. 100° C. The hot solution is then titrated immediately with ethanolic 0.05N KOH using three to four drops of 1% thymol blue in DMF indicator, the equivalence is observed when the solution turns from clear yellow to blue. A 0.5-1.0 mL excess of KOH solution is added, and the deep blue color was back-titrated to yellow end point by the addition of 0.05N isopropanolic HCl to the hot solution. The ethanolic KOH solution is previously standardized against a solution of known concentration of potassium hydrogen phthalate in water using phenolphthalein indicator.

The acid number and the maleic anhydride content were calculated as follows:

$$Acid Number ( mg KOH / g ) = \frac{{V}_{eq} \times {N}_{KOH} \times 56.1}{{m}_{polymer - g - MA}}$$

$$MA ( \% ) = \frac{acid number \times 98}{2 \times 561}$$

The grafted MA content is classified into 4 categories:
Low: 0.2-0.5%
Medium: 0.5-0.8%
High: 0.8-1%
Very high: above 1% (1-1.5%)
Ultra high: above 1.5%

The ¹³C-NMR analysis is performed using a 400 MHz or 500 MHz Bruker NMR spectrometer under conditions such that the signal intensity in the spectrum is directly proportional to the total number of contributing carbon atoms in the sample. Such conditions are well-known to the skilled person and include, for example, sufficient relaxation time etc. In practice, the intensity of a signal is obtained from its integral, i.e., the corresponding area. The data are acquired using proton decoupling, 2000 to 4000 scans per spectrum with 10 mm room temperature through or 240 scans per spectrum with a 10 mm cryoprobe, a pulse repetition delay of 11 seconds, and a spectral width of 25000 Hz (+/−3000 Hz). The sample is prepared by dissolving a sufficient amount of polymer in 1,2,4-trichlorobenzene (TCB, 99%, spectroscopic grade) at 130° C. and occasional agitation to homogenize the sample, followed by the addition of hexadeuterobenzene (C₆D₆, spectroscopic grade) and a minor amount of hexamethyldisiloxane (HMDS, 99.5+%), with HMDS serving as an internal standard. To give an example, about 200 mg to 600 mg of polymer is dissolved in 2.0 mL of TCB, followed by the addition of 0.5 mL of C₆D₆ and 2 to 3 drops of HMDS.

Following data acquisition, the chemical shifts are referenced to the signal of the internal standard HMDS, which is assigned a value of 2.03 ppm.

### EXAMPLES

### Selection of the Materials

The elastomeric matrix is an ethylene-propylene-diene monomer grafted with 1 wt. % of maleic anhydride (EPDM-g-MA) Royaltuf 498, supplied by Addivant, based on the total weight of the elastomeric matrix. This elastomer contains 31 mol. % of propylene, 66.9 mol. % of ethylene and 2.1 mol. % of diene as determined by ¹H NMR and based on the total molar content of the elastomer (see Larrue, C. et al. in “Enhancement of EPDM Crosslinked Elastic Properties by Association of Both Covalent and Ionic Networks. Polymers”, 2021. 13(18): p. 3161). Differential Scanning Calorimetry (DSC) experiments evidenced a crystallinity of 4.5%. Pyromellitic dianhydride (PMDA) and trimethylhexanemethylenediamine (TMD) were purchased from TCl Chemicals and used as received. Dicumyl peroxide (DCP) and p-xylene were purchased from Sigma Aldrich and used as received. Table 1 depicts the main characteristics of these materials.

TABLE 1
Main physical and chemical characteristics of the materials

| Name | M | Tm | Tb | Density |
|---|---|---|---|---|
| (Commercial Name) | (g/mol) | (° C.) | (° C.) | (g/cm³) |
| EPDM-g-MA | Mn: 72,000 | 123 | / | 0.89 |
| (Royaltuf 498) | Mw: 212,000 | | | |
| | as determined | | | |
| | by SEC | | | |
| PMDA | 218 | 285 | 400 | 1.68 |
| (Pyromellitic dianhydride) | | | | |
| TMD | 158 | −80 | 232 | 0.87 |
| (Trimethyl- | | | | |
| hexanemethylenediamine) | | | | |

### Synthesis of EPDM-q-MA/PI Blends

### Polyimide Phase

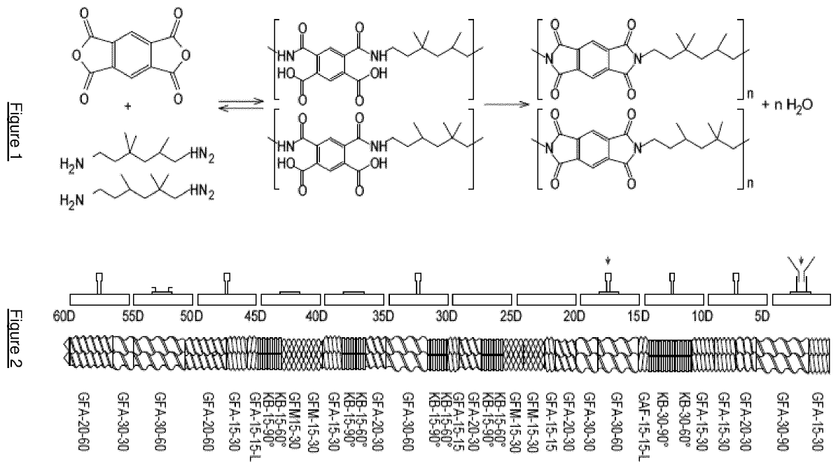

The polyimide phase was in situ synthesized in the extruder from two non-toxic monomers. Pyromellitic dianhydride (PMDA) is a commercial dianhydride extensively used in the synthesis of commercial polyimides such as Kapton® and well known to confer a highly rigid structure to the resulting polymers (Tg=385° C. for Kapton®). The diamine is a mixture of (2,2,4) and (2,4,4) trimethylhexanemethylenediamine (TMD) (two flexible aliphatic diamine isomers produced by Evonik). The incorporation of these diamines in the polyimide structure (displayed in FIG. 1) was expected to bring flexibility to the polymer chains. Differential Scanning Calorimetry (DSC) experiments evidenced the glass transition temperature of this amorphous polyimide at 150° C.

### In Situ Synthesis by Reactive Extrusion

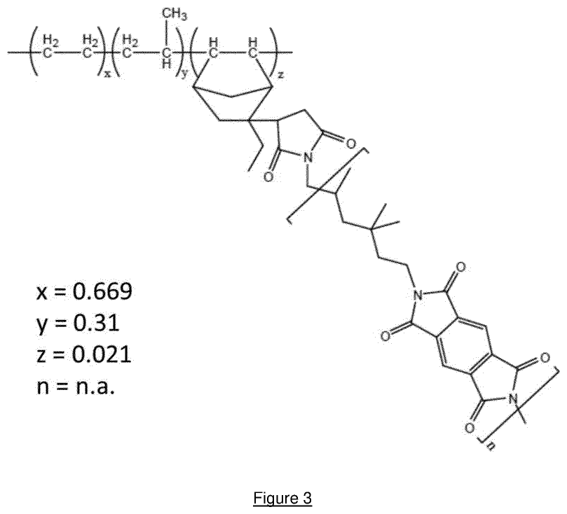

Different blends were synthesized by melt-blending in a co-rotating twin-screw extruder (Leistritz ZSE18HPe-60D model, diameter 18 mm, L/D=60) at 200° C. and screw speed of N=600 rpm. The twin-screw profile is shown in FIG. 2. It particularly contains two reverse conveying elements: the first one is positioned (L/D=15) upstream of the diamine injection (L/D=17.5) to avoid the liquid from rising out, and the second one is positioned (L/D=45) at two-thirds of the extruder to create a plug upstream of the evaporation of the volatiles. The screw profile used is illustrated in FIG. 2.

Different polyimide contents were in situ synthesized in the EPDM-g-MA matrix by adding stoichiometric amounts of dianhydride and diamine. The flow rates of the different components were adapted for every formulation to maintain a total extrusion flow rate of Q=3 kg/h. A description of all the formulations is referenced in Table 2.

EPDM-g-MA and PMDA were incorporated by the main hopper, whereas TMD was incorporated in the matrix in the molten state at the injection point L/D=17.5 using an external liquid pump. The barrel elements at L/D=37.5 and L/D=57.5 were kept open to evaporate the water created during the polycondensation reaction. The mean residence time of the polymer in the extruder was calculated at 90 seconds under these processing conditions using the Ludovic software. At the die exit of the extruder, samples were cooled down with air and granulated.

TABLE 2
Blend compositions in weight %

| | Composition in wt. % | | |
|---|---|---|---|
| | EPDM-g-MA | PI | DCP |
| EPDM-g-MA/PI | 100 | 0 | — |
| in situ blends | 95 | 5 | — |
| | 90 | 10 | — |
| | 80 | 20 | — |
| | 60 | 40 | — |
| EPDM-g-MA/PI/ | 100 | 0 | 2 |
| DCP* | 80 | 20 | 2 |

*DCP added in an internal mixer and crosslinked under compression at 180° C.

After extrusion, the pellets of the different blends were injected in a hydraulic injection molding machine Battenfeld UNILOG B2 6/10P equipped with a 60 mm diameter piston and presenting a clamping force of 350 kN. Samples were injected into dog-boned shaped 1BA samples for tensile testing. Chamber temperature was set at 200° C., mold temperature at 25° C. and the injection pressure was adapted to each sample to provide an optimal filling of the mold. For rheological measurements, cylindrical samples (8 mm in diameter, 2 mm thick) were cut out of the injected samples using a punch.

### Crosslinking

As described in Table 2, the reference EPDM-g-MA and the EPDM-g-MA/PI 80/20 (weight ratio) in situ blends previously obtained by reactive extrusion were crosslinked after the addition of 2 wt. % of dicumyl peroxide (DCP) based respectively on the total weight of EPDM-g-MA and of the elastomer-polyimide blend. The addition of DCP was performed in an internal batch mixer (Haake Rheomix 600, Thermo Electron), equipped with roller blades and with a chamber capacity of 48 cm³. First, the polymer was introduced in the chamber at 130° C. and sheared for 5 min at 30 rpm to ensure thermal homogenization. DCP was then introduced, and the mixture was sheared for 3 min only to prevent the crosslinking reaction from happening inside the mixer. The obtained mixture was then compression molded into a 2 mm thick sheet for 30 minutes at 180° C. under 200 bars to ensure crosslinking of the sample.

As most existing polymers, EPDM and PI are immiscible due to their high molar mass giving them limited entropy gain upon mixing. The use of maleic anhydride grafted ethylene-propylene-diene monomer (EPDM-g-MA) was found to improve the affinity with the polyimide phase due to the maleic anhydride polar groups. Moreover, the maleic anhydride functions may act as reactive sites along the elastomer chains. As the polyimide phase is in situ synthesized during the extrusion of the elastomer, chemical grafting can take place and form copolymers with EPDM-g-MA. Indeed, the maleic anhydride function on the elastomer chains may react either with the diamine monomer or with amine end-groups of the polyimide chains. This reaction leads to the formation of a copolymer whose structure is shown in FIG. 3.

This way, in situ polymerization and in situ compatibilization happen simultaneously in the blend. This new copolymer will be located at the interface of the two polymers and will be able to stabilize the created morphology.

### Morphology Development

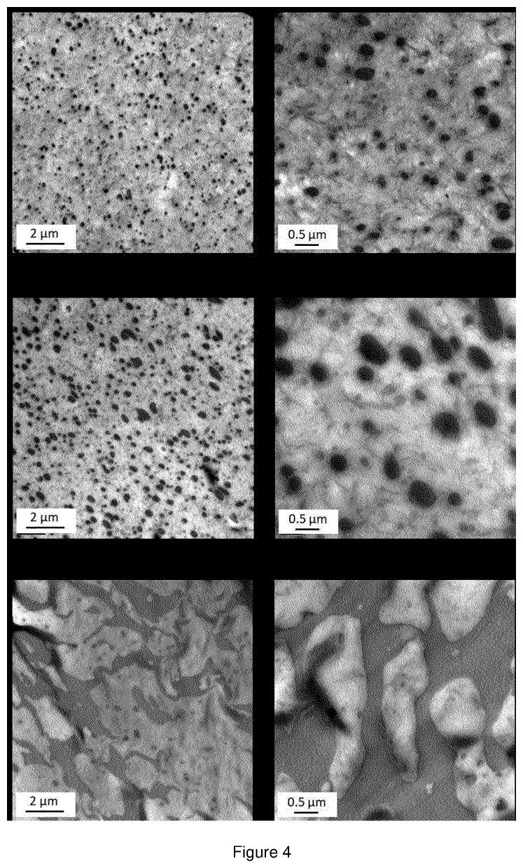

Transmission Electron Microscopy (TEM) of EPDM-g-MA/PI blends with 10 wt. % (a) and 20 wt. % (b) of polyimide based on the total weight of the elastomer-polyimide blend are shown in FIG. 4. The elastomeric matrix appears in light grey and the polyimide nodules in dark grey. Both blends exhibit a nodular homogeneous dispersion of the polyimide phase. The nodules in the elastomer-polyimide blend with 10 wt. % of PI have a diameter ranging from 60 to 280 nm, with a mean value of 130±40 nm. The nodules in the elastomer-polyimide blend with 20 wt. % of PI are slightly bigger, with PI diameters ranging from 100 to 550 nm, and a mean value of 240±80 nm. In both elastomer-polyimide blends, the polyimide nodules have good adhesion with the elastomeric matrix, as no voids are visible between the nodules and the matrix. The created morphology is stabilized due to the creation of copolymers at the interface of EPDM-g-MA and PI.

The dispersion of PI in EPDM-g-MA is very fine compared to examples of rubber/thermoplastics in the literature. Blends of EPDM and 20 wt. % of polyoxymethylene (POM) based on the EPDM blends in an internal mixer at 190° C. led to a micrometer dispersion, with particles' diameters between 1.3 to 6.2 μm depending on the compatibilizer content (see Bragaglia et al. in Journal of Applied Polymer Science, 2021. 138 (20): p. 50423). Similarly, blends of EPDM-g-MA, PI and nanosilica prepared in an internal mixer at 120° C. displayed a micrometer dispersion of polyimide and nanosilica particles (see Singh, S., et al, Composites Part A: Applied Science and Manufacturing, 2013. 44: p. 8-15). The nanometer dispersion of the PI phase is much finer in EPDM-g-MA/PI in situ blends prepared by reactive extrusion.

FIG. 4c) displays the morphology of the EPDM-g-MA/PI 60/40 (weight ratio) blend. First, it can be noticed that the morphology is completely different from the blends with a lower PI content. With 40 wt. % of PI based on the total weight of the elastomer-polyimide blend, the morphology of the material is co-continuous between EPDM-g-MA and PI.

### Mechanical Properties

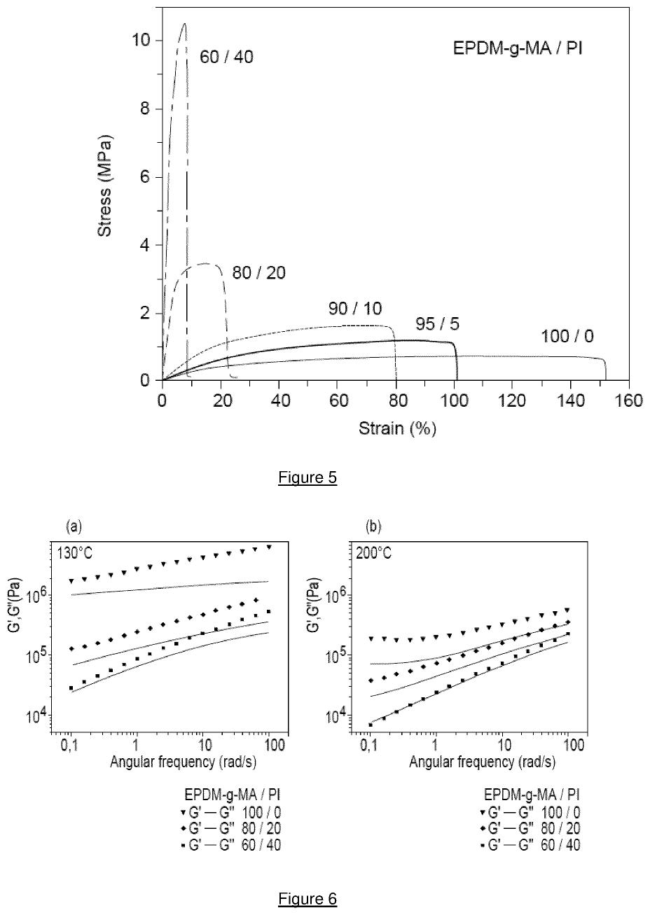

The mechanical properties of EPDM-g-MA/PI blends were investigated by tensile tests; the results are given in Table 3 and the tensile curves are displayed in FIG. 5. By adding polyimide, the stress-strain curve changes towards higher modulus and maximum stress but decreased strain at break. The addition of polyimide highly stiffens the material. With only 5 wt. % of PI based on the total weight of the elastomer-polyimide blend, Young's modulus is increased by +40%, and it is more than doubled with 10 wt. % of PI. The increase in Young's modulus is even more impressive when the polyimide concentration is increased, as it is multiplied by 18 for 20 wt. % of PI and by 74 for 40 wt. % of PI. This can be explained by the reinforcing character of the polyimide phase which is solid at room temperature. The reinforcement of the material is also observed on the maximal stress which highly increases with the polyimide concentration, from 0.7 MPa for pure EPDM-g-MA to 10.8 MPa with 40 wt. % of PI. This increase in tensile strength indicates that there is a good stress transfer between the polyimide and the elastomer phase, with a strong interface. However, it is clear from the results and the tensile curves that the polyimide concentration influences greatly the ductility of the material. Indeed, the elastomeric matrix has a strain at break of 125%, and this value decreases proportionally with the polyimide content to reach 9% with 40 wt. % of PI. Overall, the in situ synthesis of polyimide is an efficient way to organically reinforce an elastomeric matrix, but it impacts the elasticity of the material.

TABLE 3
Mechanical properties of EPDM-g-MA/PI reactive blends

| | Young | Equilibrium | Maximal | Stress | Strain |
|---|---|---|---|---|---|
| EPDM-g-MA/PI | Modulus | Modulus* Ge | Stress | at break | at Break |
| (weight ratio) | (MPa) | (MPa) | (MPa) | (MPa) | (%) |
| 100/0 | 3.8 ± 0.1 | — | 0.7 ± 0 | 0.4 ± 0 | 125 ± 3 |
| 95/5 | 5.4 ± 0.2 | 0.05 ± 0.02 | 1.1 ± 0 | 0.7 ± 0.1 | 100 ± 4 |
| 90/10 | 8.8 ± 1 | 0.08 ± 0.01 | 1.6 ± 0.1 | 0.8 ± 0.1 | 75 ± 7 |
| 80/20 | 72 ± 4 | 0.10 ± 0.05 | 3.5 ± 0.1 | 3 ± 0 | 25 ± 2 |
| 60/40 | 280 ± 15 | 1.5 ± 0.2 | 11 ± 0.5 | 9.3 ± 0.4 | 9 ± 0.3 |

Equilibrium modulus Ge measured at T = 130° C.

### Rheological Behavior

FIG. 6 shows the dynamic rheological response of EPDM-g-MA/PI blends as a function of angular frequency with various polyimide concentrations. For more clarity, only the reference and the elastomer-polyimide blends with 20 wt. % and 40 wt. % of PI based on the total weight of the elastomer-polyimide blends are represented. The moduli of all concentrations are represented in FIG. 11. The experiments were performed at 130° C., i.e., under the glass transition temperature of the polyimide of the polyimide phase (T_{g}=150° C.), and at 200° C. over the glass transition temperature of the polyimide of the polyimide phase.

As expected, all elastomer-polyimide blends display higher moduli in the presence of polyimide compared to the EPDM-g-MA pure matrix. For the elastomer-polyimide blend with 40 wt. % of PI, both moduli tend to have a constant value at low frequency, which is similar to the behavior of a crosslinked elastomer. FIG. 7 displays the storage and loss modulus of the blend EPDM-g-MA/PI 80/20 (weight ratio) at 130° C. and 200° C. The values of the moduli are lower at 200° C. compared to 130° C. as the analysis is carried out at a temperature over the glass transition of the polyimide of the polyimide phase. The polyimide phase brings a real reinforcement of the matrix at low temperatures, due to the dispersion of rigid PI nodules in the matrix.

Elastomers reinforced with fillers often display what is called the Payne effect, i.e. the strain-dependence of the dynamic viscoelastic properties of the material due to the break-down of the three-dimensional network formed by the aggregated filler particles. This non-linear behavior affects the performance of the materials. This effect is observed beyond a strain of 0.1% from a strong decrease in the storage modulus. The amplitude of the Payne effect increases with the filler content and the specific surface of the filler but it decreases with the temperature.

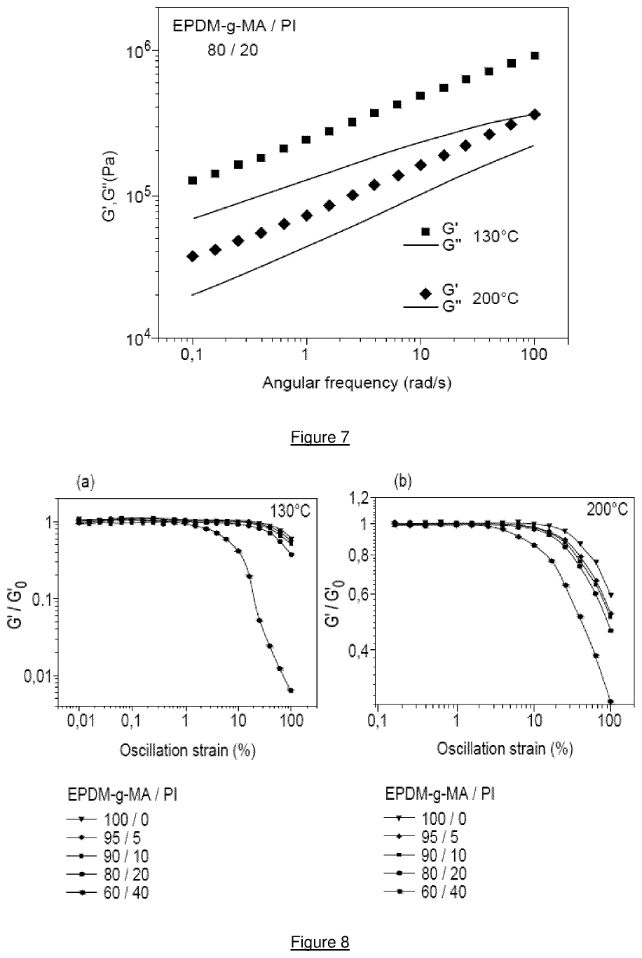

FIG. 8 displays the linear behavior of the EPDM-g-MA/PI blends, with a representation of the storage modulus G′ divided by the storage modulus at the lowest oscillation strain called G′0. As displayed on the graphs, the linear regime of EPDM-g-MA/PI blends is similar to the one of pure EPDM-g-MA, for all PI concentrations up to 20 wt. % based on the total weight of the elastomer-polyimide blend. This behavior is the same at 130° C. and at 200° C., meaning that the linear regime is not altered when the polyimide is solid in the material. This can be explained by the very fine dispersion of the polyimide nodules in the matrix. Indeed, TEM images evidenced a homogeneous dispersion of the polyimide nodules in the matrix, without any aggregates for the 10 and 20 wt. % PI contents. This behavior is interesting for a reinforced elastomeric material, as elastomers/inorganic fillers nanocomposites usually display a non-linear regime due to the breakdown of the filler aggregates.

However, for the blend with 40 wt. % of PI, the variation of the storage modulus is less linear and is different compared to the other blends. At 130° C., the storage modulus is stable until a strain of 1% where it strongly decreases. The non-linear behavior for this blend could come from the co-continuous morphology of the blend, as the deformation can disrupt the hard PI domains.

### EPDM-g-MA/PI/DCP Crosslinked Blends

Elastomers are most of the time crosslinked before use to have a maximum elastic recovery. To study the impact of the in situ synthesized polyimide phase on the crosslinked network, one blend with 20 wt. % of PI based on the total weight of the elastomer-polyimide blend was crosslinked with the addition of 2 wt. % of DCP based on the total weight of the elastomer-polyimide blend in an internal mixer and then cured in a hot press. As displayed in Table 4, the elastic recovery of the elastomer-polyimide blend was improved in presence of 20 wt. % of PI in the material. Indeed, the compression set value is at 23% for pure cured EPDM-g-MA and 19% with polyimide in the material. This improvement could come from the covalent bonds created between EPDM-g-MA and the polyimide phase. The presence of EPDM-g-PI copolymers associated with the crosslinked elastomer creates a double network which gives more elastic recovery to the material. The cross-linking efficiency was not modified in presence of PI, as the glass fraction is similar for the EPDM-g-MA/PI/DCP 80/20/2 (weight ratio) blend and the reference, around 93%. However, the swelling equilibrium was decreased in presence of polyimide in the blend, meaning that the material is more densely crosslinked. This is probably due to the creation of the double network mentioned above.

TABLE 4
Compression set (Cs), gel fraction (GF) and
swelling ratio (Se)of EPDM-g-MA/PI/DCP blends

| EPDM-g-MA/PI/DCP | Cs | GF | Se |
|---|---|---|---|
| (weight ratio) | (%) | (%) | (%) |
| 100/0/0 | 80 ± 3 | / | / |
| 80/20/0 | 75 ± 3 | 34 ± 8 | 17.7 ± 6.8 |
| 100/0/2 | 23 ± 2 | 93 ± 2 | 5.1 ± 0.4 |
| 80/20/2 | 19 ± 3 | 93 ± 1 | 3.5 ± 0.7 |

### Mechanical Properties of EPDM-q-MA/PI/DCP Blends

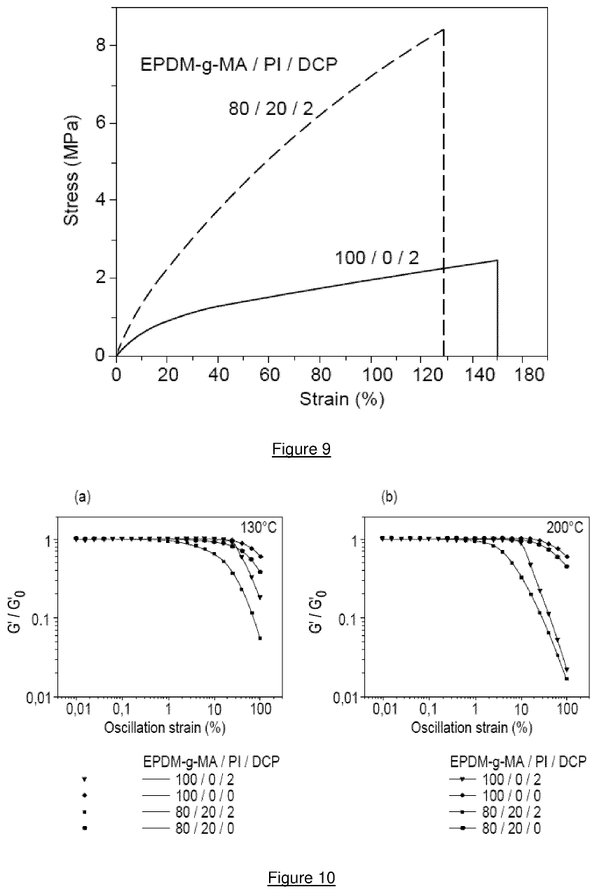

The mechanical properties of EPDM-g-MA/PI/DCP blends were investigated by tensile tests; the results are given in Table 5 and the tensile curves are displayed in FIG. 9. For comparison purposes, the tensile curves of the same non-crosslinked materials are displayed on the graph. The crosslinking of the elastomer phase increases greatly its Young's modulus, maximal stress and stress at break, without modifying its strain at break. With 20 wt. % of polyimide, Young's modulus is doubled compared to pure crosslinked EPDM-g-MA, and the strain at break is only decreased by 10%. Though the increase of Young's modulus is important; it is much less significant than in the same non-crosslinked blend where Young's modulus was multiplied by 18. Overall, the in situ synthesis of polyimide reinforces the elastomer without impacting its elasticity.

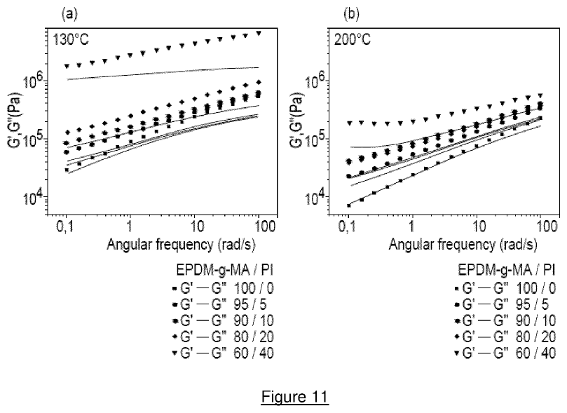

FIG. 10 displays the linear behavior of the EPDM-g-MA/PI/DCP blends. For comparison purposes, the linear behaviors of the same non-crosslinked materials are displayed on the graph. The linear regime of EPDM-g-MA/PI/DCP blends is close to the one of pure crosslinked EPDM-g-MA. With 20 wt. % of PI, the storage modulus decreases from 1% of strain, when it decreases only from 10% of strain for crosslinked EPDM-g-MA. As mentioned above, the presence of PI generates a superposition of two networks and thus a higher apparent crosslinking density, which leads to a smaller linear domain. This behavior is the same at 130 and at 200° C., meaning that the strain-dependence of the storage modulus is not altered when the polyimide is solid in the material. For both crosslinked blends, there is a higher strain dependence of the storage modulus compared to the non-crosslinked materials.

1-17. (canceled)

18. A process to produce a reinforced elastomeric material characterized in that it comprises:
a) providing components comprising a grafted elastomer, one or more dianhydrides, and one or more diamines; wherein the grafted elastomer is provided at a content of at least 60 wt. % based on the total weight of the components; and wherein the elastomer of the grafted elastomer is selected from natural rubber, epoxidized natural rubber, styrene-butadiene rubber, nitrile rubber, chloroprene rubber, ethylene propylene rubber, ethylene-propylene-diene monomer (EPDM) elastomer, butyl rubber, chlorobutyl rubber, acryl rubber, silicone rubber, fluorine-containing rubber, butadiene rubber, epoxidized butadiene rubber, epichlorohydrin rubber), urethane rubber, polysulfide rubber, ethylene-octene copolymer; thermoplastic elastomers;
b) performing in situ synthesis of a polyimide phase in the grafted elastomer by reactive extrusion of the components in a twin-screw extruder comprising a main hopper wherein the screw profile comprises two or more reverse conveying elements forming two or more hot zones to form an elastomer-polyimide blend; and
c) recovering said elastomer-polyimide blend being a reinforced elastomeric material wherein the polyimide of the elastomer-polyimide blend is present at a content from 3 to 40 wt. % based on the total weight of the reinforced elastomeric material.

19. The process according to claim 18 is characterized in that the polyimide of the elastomer-polyimide blend recovered at step (c) has a glass temperature transition of at least 100° C. as determined by DSC at a heating rate of 10° C./min under nitrogen; with preference, the polyimide of the elastomer-polyimide blend recovered at step (c) has a glass temperature transition ranging from 100° C. to 250° C.

20. The process according to claim 18 is characterized in that the grafted elastomer comprises from 0.2 to 6.0 wt. % of a grafting agent based on the total weight of grafted elastomer determined according to the method identified in the description; and/or the grafted elastomer comprises a grafting agent comprising or being one or more functional monomers selected from maleic anhydride, glycidyl methacrylate, methyl methacrylate, acrylic acid, butyl acrylate, vinyl acetate, diethyl maleate, acrylamide, and any mixture thereof.

21. The process according to claim 18 is characterized in that the elastomer of the grafted elastomer is or comprises ethylene-propylene-diene monomer (EPDM) elastomer.

22. The process according to claim 21 is characterized in that the grafted EPDM elastomer has:
an ethylene content ranging from 40 to 75 mol. % based on the total molar content of the grafted EPDM elastomer as determined by ¹H NMR; and/or
a diene content ranging from 1.0 to 3.0 mol. % as determined by ¹H NMR; and/or
a number average molecular weight Mn ranging from 50 000 to 250 000 g/mol as determined by size-exclusion chromatography; with preference from 50 000 to 100 000 g/mol.

23. The process according to claim 18 is characterized in that the one or more dianhydrides provided at step (a) are selected from pyromellitic dianhydride (PMDA) 3,3′,4,4′-benzophenone tetracarboxylic dianhydride (BTDA), 3,3′,4,4′-biphenyl tetracarboxylic dianhydride (BPDA), 1S,2R,4S,5R-cyclohexanetetracarboxylic dianhydride (H-PMDA), 1,2,3,4-cyclobutanetetracarboxylic dianhydride (CBDA), bicyclo-[2.2.2]oct-7-ene-2-exo,3-exo,5-exo,6-exo-2,3:5,6-dianhydride (BTA), and any mixture thereof.

24. The process according to claim 18 is characterized in that one or more dianhydrides provided at step (a) are one or more aromatic dianhydrides; with preference, the one or more aromatic dianhydrides are or comprise pyromellitic dianhydride, 3,3′,4,4′-benzophenone tetracarboxylic dianhydride, 3,3′,4,4′-biphenyl tetracarboxylic dianhydride, and any mixture thereof.

25. The process according to claim 18 characterized in that one or more diamines provided at step (a) are one or more branched aliphatic diamines; with preference, the one or more branched aliphatic diamines are selected from trimethyl hexamethylenediamine, methyl pentamethylenediamine, and methyl octamethylenediamine.

26. The process according to claim 18 characterized in that the two or more reverse conveying elements are selected from kneading left-handed element and/or left-handed elements; with preference, the two or more hot zones comprise a first hot zone with successive kneading blocks elements over a length of at least 4 D followed by a left-handed element, with D being the screw diameter, and one or more additional hot zones placed downstream of the first hot zone, said one or more additional hot zones being filled mixing zones, each comprising kneading blocks elements over a length of at least 4 D followed by a kneading left-handed element or by a left-handed element, with D being the screw diameter.

27. The process according to claim 18 characterized in that the polyimide of the elastomer-polyimide blend recovered at step (c) is an aliphatic-aromatic polyimide; and/or in that the reinforced elastomeric material is crosslinked and the process further comprises a step (d) of crosslinking the elastomer-polyimide blend recovered at step (c) by addition of from 1.0 to 10.0 wt. % of a crosslinking agent based on the total weight of the elastomer-polyimide blend; with preference, the crosslinking agent is or comprises dicumyl peroxide.

28. The process according to claim 18 characterized in that the reinforced elastomeric material comprises an elastomeric matrix phase and a polyimide phase which are co-continuous phases; or
in that the reinforced elastomeric material comprises an elastomeric matrix phase and a polyimide phase wherein the polyimide phase is present in the form of dispersed nodules with an average diameter of less than 1000 nm as determined by TEM; with preference ranging from 80 to 500 nm.

29. A reinforced elastomeric material produced by the process according to claim 19, is characterized in that it comprises an elastomeric matrix phase and a polyimide phase wherein the polyimide of the polyimide phase has a glass temperature transition ranging from 100° C. to 250° C. as determined by DSC at a heating rate of 10° C./min under nitrogen and is present in a content of from 3 to 40 wt. % based on the total weight of the reinforced elastomeric material.

30. The reinforced elastomeric material according to claim 29 is characterized in that the reinforced elastomeric material is a reinforced ethylene-propylene-diene elastomer and/or in that the polyimide of the polyimide phase is an aliphatic-aromatic polyimide.

31. The reinforced elastomeric material according to claim 29 is characterized in that the reinforced elastomeric material comprises an elastomeric matrix phase and from 3 to less than 35 wt. % of a polyimide phase based on the total weight of the reinforced elastomeric material and in that the polyimide phase is present in the form of dispersed nodules with an average diameter of less than 1000 nm as determined by TEM; preferably, ranging from 50 to 600 nm or from 110 to 300 nm.

32. The reinforced elastomeric material according to claim 29 is characterized in that the reinforced elastomeric material comprises an elastomeric matrix phase and at least 35 wt. % of a polyimide phase based on the total weight of the reinforced elastomeric material and in that the elastomeric matrix phase and the polyimide phase are co-continuous phases.

33. The reinforced elastomeric material according to claim 29 is characterized in that it is a cross-linked material.

34. The reinforced elastomeric material according to claim 29 is characterized in that it is devoid of reinforcing material selected from silica and/or carbon black; or comprises one or more reinforcing elements selected from carbon black and/or silica wherein one or more reinforcing elements are present at a content of at most 2.0 wt. % based on the total weight of the reinforced elastomeric material.
